(19) United States
(12) Patent Application Publication
(10) Pub. No.: US 2019/0359294 A1
(43) Pub. Date: Nov. 28, 2019

(54) SHIP-TO-SHIP TRANSFER SYSTEM AND METHOD FOR LIGHTERING

(71) Applicant: Ryan Lee SULLIVAN, Hampton Bays, NY (US)

(72) Inventor: Ryan Lee SULLIVAN, Hampton Bays, NY (US)

(21) Appl. No.: 16/418,466

(22) Filed: May 21, 2019

Related U.S. Application Data
(60) Provisional application No. 62/674,906, filed on May 22, 2018.

(51) Int. Cl. B63B 27/34; B63B 27/25; B67D 9/02

(52) U.S. Cl. CPC B63B 27/34; F17C 2270/0105; B67D 9/02; B63B 27/25

(57) ABSTRACT

The present invention relates to a system and method for ship-to-ship transfers and/or replenishments of a resource to a ship during lightering. In particular, the ship-to-ship transfer system includes one or more single-point moorings (e.g., CALM, SALM, or ELSBM buoys) fluidly connected to one another and, optionally, a pumping station or utility ship to facilitate the transfer of the resource. Each single-point mooring is positioned at the water surface at a lateral distance away from the other single-point moorings. Each single-point mooring is fluidly coupled to one another via a series of pipes on or near the sea floor and also includes a fluidic coupling (e.g., a floating hose assembly) that may be connected to a ship. The ship-to-ship transfer system may also be used for storage of resources, delivery of liquid consumables, and/or receipt of liquid waste.

This application claims the priority benefit of provisional U.S. patent application No. 62/674,906, filed on 22 May 2018, the contents of which are incorporated herein in their entirety by reference.

### FIELD OF THE INVENTION

The present invention relates to a system and method for ship-to-ship transfers and/or replenishments of a resource to a ship during lightering. In particular, the ship-to-ship transfer system includes one or more single-point moorings or monobuoys (e.g., CALM, SALM, or ELSBM buoys) fluidly connected to one another and, optionally, a pumping station or utility ship to facilitate the transfer of the resource. Each single-point mooring is positioned at the water surface at a lateral distance away from the other single-point moorings. Each single-point mooring is fluidly coupled to one another via a series of pipes, valves, and manifolds on or near the sea floor and also includes a fluidic coupling (e.g., a floating hose assembly) that may be connected to a ship. The ship-to-ship transfer system may also be used for storage of resources, delivery of liquid consumables, and/or receipt of liquid waste.

### BACKGROUND

The most economical way to move large volumes of crude oil for long hauls is aboard Very Large Crude Carriers (VLCC). A VLCC is a tanker of 290,000 to 320,000 tons, with a laden draft of 70 to 75 feet (21 to 23 meters) and capable of loading about 2 m bbls.

Traditional ship-to-ship transfers of a resource (e.g., oil) are performed by mooring two ships (e.g., tankers) closely together with a set of fenders (i.e., bumpers) separating the ships such that one ship may directly connect to the other ship to transfer the resource. This method of ship-to-ship transfer is time-consuming, inherently dangerous because two tankers are brought in close proximity to one another in the open sea, and may fail for many different reasons. For example, when two tanker ships are coupled to one another in the open sea during a ship-to-ship transfer of resources as described above, there is a risk of collision or allision between the ships while maneuvering towards each other or fendered to each other due to factors such as unpredictable weather, equipment failure, or human error. Moreover, unpredictable weather can also prevent the mooring step from occurring at all or cause the two ships to need to disconnect mid-transfer due to safety concerns. Lightering operations are not carried out during adverse weather conditions such as swells over 2.2 meters, wind over 25 knots, fog and reduced visibility under 3 nautical miles, and are sometimes limited to daylight hours. These restrictions do not allow for continuous lightering procedures. Lastly, traditional ship-to-ship transfer methods can currently transfer resources from one ship to another ship. Due to safety concerns, lighterings do not currently operate with more than two vessels at a time where the two vessels are fendered together and moored. Consequently, even though lightering handles the largest volume of VLCCs, it is an inefficient method and capable of only one transfer at a time. Under optimal conditions, it takes at least 6 days and four separate operations to complete a full transfer to or from one VLCC.

Other transfer methods are known for loading or unloading a VLCC. The Louisiana Offshore Oil Port (LOOP) consist of three single-point moorings connected to a pipeline which runs into shore-based storage and a limited distribution with heavy onshore infrastructure. LOOP is capable of loading or unloading a fully-laden VLCC due to its offshore location and can operate in inclement weather. However, the LOOP distribution system for imports is limited to the Mississippi River area refineries. Due to the length and size of the pipes running to shore, exporters of MARS-grade crude oil have to accept up to 500,000 barrels of whichever crude was previously in the pipeline when loading a ship.

The Oxy Ingleside Terminal in Corpus Christi, Tex. is one of the largest crude export terminals in the U.S. and receives deliveries from the Cactus Oil Pipeline. The terminal has an initial draft of about 42 feet (13 meters) and plans to dredge to about 54 feet (16 meters) and therefore is capable of loading approximately 1.2 mbbls on a VLCC. A lightering operation is still required to fully fill a VLCC.

Currently, all U.S. Gulf ports have drafts (maximum depth below the waterline) ranging between 38 feet to 45 feet (12 meters to 14 meters). The LOOP terminal is the sole terminal in the Gulf without a draft restriction. These draft considerations restrict the bulk of VLCC transfers to be performed via lightering.

Accordingly, a need exists for a ship-to-ship transfer system that would allow for quicker and safer transfer of resources between ships. Moreover, a need also exists for a ship-to-ship transfer system that allows multiple ships to be loaded and/or discharged simultaneously.

### SUMMARY OF THE INVENTION

A ship-to-ship transfer system of the present invention includes a first mooring positioned at a water surface and anchored to a sea floor, and a second mooring positioned at the water surface and anchored to the sea floor, said second mooring in fluid communication with the first mooring via a pipe. The ship-to-ship transfer system may include a third mooring fluidly coupled to the first mooring and the second mooring via the pipe. The ship-to-ship transfer system may further include a pumping station (or a utility ship) having one or more pumps or booster pumps fluidly coupled in between the first mooring and the second mooring. The first mooring may include a first hose extending therefrom and the second mooring may include a second hose extending therefrom. The first hose may be coupled to an offloading ship while the second hose may be coupled to a receiving ship to thereby transfer a resource between the two ships. In the case of two or more moorings, a manifold which may have a plurality of crossover pipes and/or valves can be located within the system to direct flow.

The ship-to-ship transfer system may include any suitable number of inline booster pumps located along the pipes, at a pumping station (which may be a utility ship), or at a control manifold. In a system with more than two buoys, a manifold connected to the pipelines may be used in order to direct flows of the resource. The manifold or a pumping station may be deployed at any appropriate location such as near or on the surface of the water, below the water surface, or near or below the sea floor. In a preferred embodiment, only the pumps on a ship are used without needing additional pumps.

A method of using the ship-to-ship transfer systems described above includes providing a first mooring in fluid communication with a second mooring; and pumping the resource from a first ship fluidly coupled to the first mooring into a second ship fluidly coupled to the second mooring. In the embodiment with a pumping station or utility ship, the method may include pumping the resource from the first mooring to the pumping station or utility ship. The pumping station or utility ship may then pump the resource into one or more receiving ships using a control manifold to direct the flow of the resource. In the embodiment without the use of the pumping station or utility vessel, the resource may be pumped using the cargo pump of the offloading vessel into multiple receiving vessels at the same time with the use of a control manifold.

Lightering of a VLCC to four AFRAMAX-type vessels typically involves four separate operations and takes six days under ideal conditions. If there are any delays, such as due to poor weather conditions, lightering can take eight days, or ten days or more if there are very extensive delays. In contrast, the present invention allows a VLCC to load from or discharge to multiple vessels simultaneously and therefore can reduce the load/discharge time to about 1.5 days and a single operation, thereby dramatically increasing efficiency and reducing turnaround time as compared to conventional lightering. Unlike the LOOP system or other offshore terminals similar to LOOP, the inventive ship-to-ship system transfer system provides the same flexibility with regard to cargo sourcing and/or distribution as lightering because the sourcing and/or distribution is not limited to one specific terminal.

The present invention can also be used to facilitate bunkering during cargo operations. Due to port restrictions which exclude VLCCs from calling in most terminals, such vessels must bunker offshore. These offshore bunkering operations are vulnerable to the same environmental conditions that can curtail standard lightering procedures. The owners of a vessel typically pay a premium for delivery of bunkers after cargo operations have been completed. Advantageously, the present invention allows for delivery of bunkers at the same time as cargo operations. Thus, the invention provides a valuable time savings for vessel owners. Because of the draft restrictions on a vessel such as a VLCC when it calls at a terminal, it is preferred to bunker the vessel after loading cargo.

Dimensions are provided herein in both metric and Imperial units which have been rounded to ease discussion. The dimensions are therefore intended to be representational and not limiting.

### BRIEF DESCRIPTION OF THE DRAWINGS

FIGS. 1A and 1B illustrate ship-to-ship transfer systems having five single-point moorings fluidly coupled to one another in the sea. FIG. 1C illustrates the ship to-ship transfer system of FIG. 1A. with a direct connection between single-point moorings without a manifold.

FIG. 2A illustrates a ship-to-ship transfer system having a manifold and eight single-point moorings.

FIG. 2B illustrates a ship-to-ship transfer system having a manifold and six single-point moorings.

FIG. 3 illustrates a ship-to-ship transfer system wherein an offloading ship and a receiving ship are fluidly coupled via a manifold.

FIGS. 4A and 4B illustrates a Catenary Anchor Leg Mooring (CALM) buoy that can be used as a single-point mooring for a ship.

FIG. 5 illustrates five interconnected manifolds.

FIG. 6 illustrates a ship-to-ship transfer system having two mooring positions connected by an underwater piping system in which the pipes are suspended above the sea floor.

### DETAILED DESCRIPTION

The invention generally relates to a system and method for improved ship-to-ship transfer of a resource, which may be a liquid cargo (e.g., oil) or other non-cargo liquid (e.g., bunkers or slop water). The ship-to-ship transfer system described herein may generally be used to load or unload any type of ship, e.g., tankers, via an interconnected network of pipes and single-point moorings that can fluidly couple to the cargo manifold of a ship. In particular, the ship-to-ship transfer system includes two or more single-point moorings (e.g., CALM, SALM, or ELSBM buoys, (sometimes referred to as monobuoys) fluidly connected to one another in the sea via at least one pipe. Optionally, a pumping station or utility ship attached to a single-point mooring may be positioned in between the single-point moorings (and fluidly coupled to all single-point moorings) to help facilitate the transfer of the resource through the use of, e.g., a booster pump. Each single-point mooring may include a coupling (e.g., a floating hose assembly) to thereby fluidly couple a ship to the single-point mooring. Each of the single-point moorings may further include a riser or series of risers connected to a pipeline end manifold (PLEM) and a series of pipes (e.g., one, two, three, or four pipes) to connect to one another or to connect to a manifold or pumping station/ship. This ship-to-ship transfer system physically separates the offloading ship(s) and receiving ship(s) apart from one another and allows for simultaneous discharge or loading of more than one ship at a time, thus facilitating safe and quick ship-to-ship transfer operations in almost all types of weather conditions (particularly large swells and fog). The single-point moorings safely moor and carry out cargo operations in swell and wind conditions which would normally shut down conventional ship-to-ship lightering operations.

The ship-to-ship transfer system described herein may significantly reduce the amount of time to offload from or load to a larger tanker to or from one or more smaller tankers or transfer between ships of the same size. In some embodiments, the ship-to-ship transfer system may offload a tanker into one or more smaller tankers in less than a day. Moreover, multiple transfer operations (i.e., pumping and/or receiving) may occur simultaneously or the ship-to-ship transfer system may be used to mix two or more resources together in a location and the mixture pumped to a receiving ship. The systems and methods described herein may also be applied in other suitable bodies of water, for example, an ocean, bay, or sound. The invention may also provide bunkering capabilities, and the bunkers may be deployed at any appropriate location, such as any of the single-point moorings or ships.

The invention will now be described with reference to the Figures, wherein like reference numerals refer to like elements.

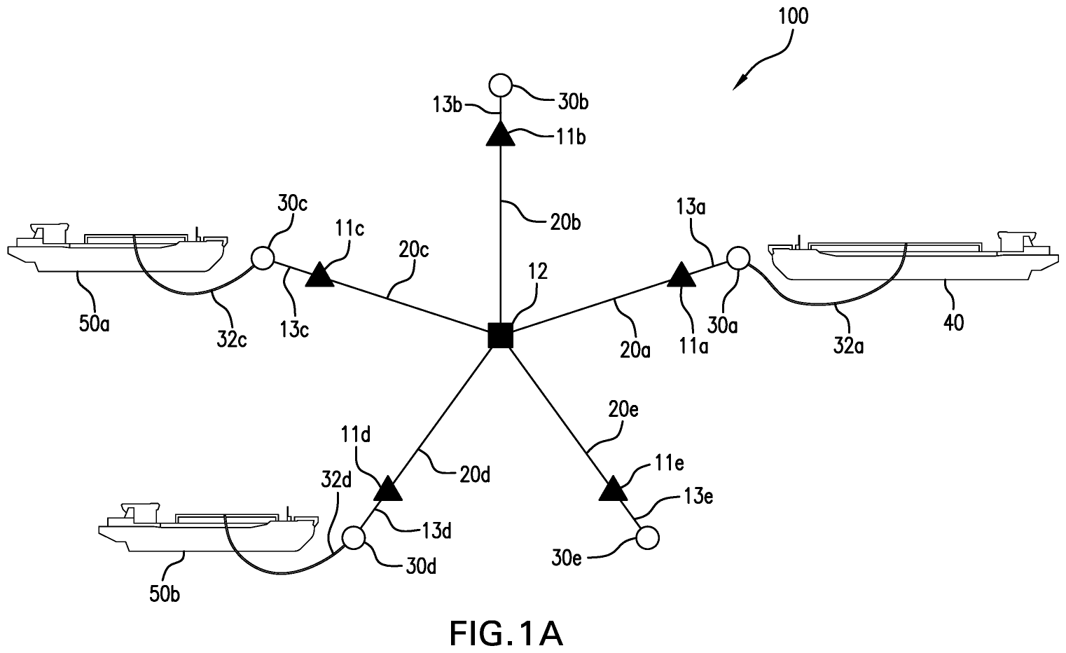

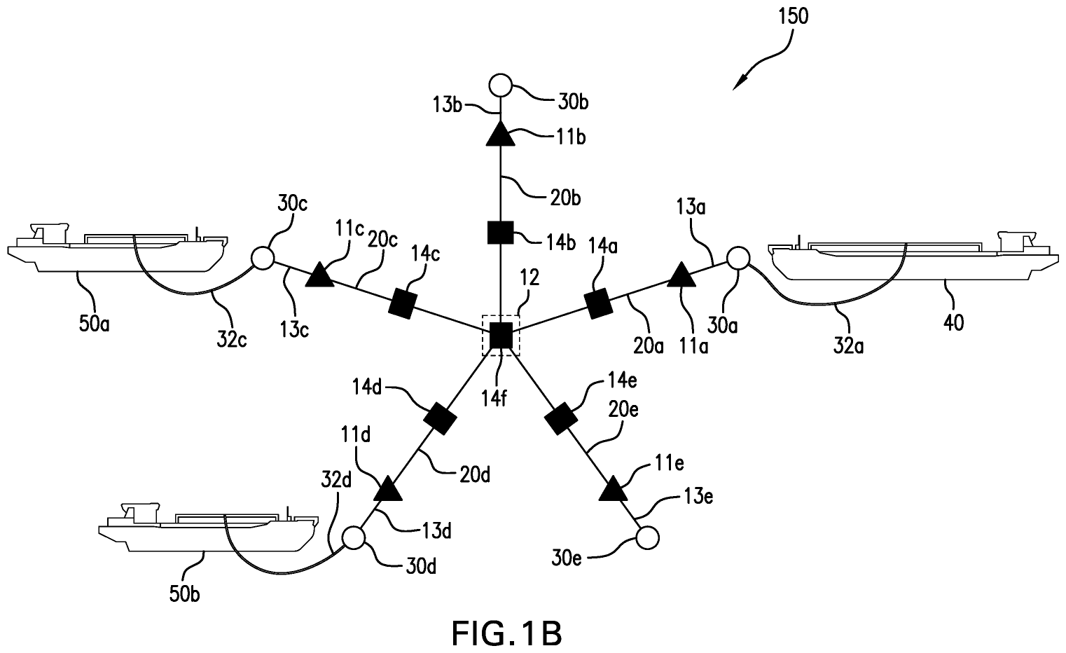

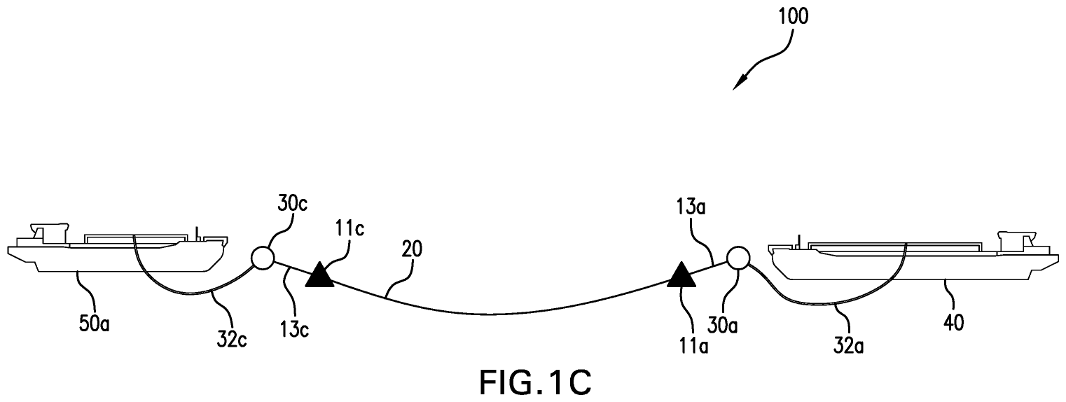

FIG. 1A illustrates a ship-to-ship transfer system 100 having five single-point moorings 30a-30e fluidly coupled to one another in the sea. In particular, the ship-to-ship transfer system 100 may include any suitable number of single-point moorings (e.g., two to twenty) spaced at a distance away from one another sufficient enough to allow for the safe navigation, mooring, and/or unmooring of vessel through a variety, preferably all, weather conditions. The distance may be, for example, between about 0.1 km to about 5 km. The distance is preferably about 1.5 km. In the embodiment shown in FIG. 1A, the single-point moorings 30a-30e are spaced in a radial formation (i.e., each single-point mooring radiates from a point) around a manifold 12 which is used to direct flows of the resource being distributed. However, in other embodiments, the single-point moorings 30a-30e may be spaced in any suitable formation, such as a linear formation where each single-point mooring is coupled to a single, linear pipe.

The single-point moorings 30a-30e are fluidly connected to one another by pipes 20a-20e and PLEMs 11a-11e that may be fixed to or embedded in the sea floor or located at a height above the sea floor. The pipes 20a-20e may be made of any offshore industry-suitable petroleum piping, such as steel or a polymer. The pipes 20a-20e may be flexible in whole or in part. Each segment of pipes 20a-20e between the single-point moorings 30a-30e may have a diameter of 200 mm to 2.5 m and a length of between 0.1 km and 10 km. Any of the pipes 20a-20e illustrated may include one or more individual pipes for the transfer of resources. For example, pipe 20a may include three different pipes, where each of the three pipes is configured to transfer a different resource, such as different types of crude oil (e.g., sweet, heavy, and/or light). The single-point moorings 30a-30e are connected to the manifold 12 via PLEMs 11a-11e. The PLEMs 11a-11e may be on or near the sea floor or at a distance above the sea floor as deemed appropriate. The PLEMs may be made of any offshore industry-suitable petroleum piping such as steel or a polymer. Each of the PLEMs 11a-11e should be sufficiently designed to accommodate the pipe and hose diameters of the components of the system. Each of the PLEMs 11a-11e is connected to respective single-point moorings 30a-30e via subsea hoses 13a-13e.

The single-point moorings 30a-30e may be a floating buoy (e.g., CALM, SALM, or ELSBM buoy) anchored to the sea floor to which ships (e.g., tankers) can moor to and remain in a fixed position in the water. Examples of a CALM/SALM buoy is the CALM and SALM buoys manufactured by The Monobuoy Company. Each single-point mooring 30a-30e may have one or more fluidic couplings 32a, 32c, 32d (e.g., floating hose assemblies) above the waterline which may be lifted onboard a ship and connected to the cargo manifold of the ship. The underside of each single-point mooring 30a-30e is connected to one or more pipes 20a-20e on or near the sea floor fluidly via a respective subsea hose 13a-13e and PLEM 11a-11e connecting each single-point mooring to one another. The pipes 20a-20e may each include a riser (i.e., a flexible hose coupling the single-point mooring to subsea pipes via a PLEM on or near the sea floor). In an example, an offloading ship 40, e.g., a very large crude carrier (VLCC) or ultra large crude carrier (ULCC), may couple to one of the single-point moorings 30a via floating hose assembly 32a (and a mooring line, such as a Hawser arrangement). A first receiving ship 50a, e.g., an average freight rate assessment (AFRAMAX) ship or SUEZMAX ship, may couple to another single-point mooring 30c via floating hose assembly 32c (and a mooring line, such as a Hawser arrangement), and a second receiving ship 50b, e.g., an AFRAMAX or SUEZMAX ship, may couple to another single-point mooring 30d via floating hose assembly 32d (and a mooring line, such as a Hawser arrangement). to thereby transfer a resource (e.g., oil) from the offloading ship 40 to the two receiving ships 50a, 50b.

The single-point moorings 30a-30e may be coupled together via a manifold that may selectively direct the flow of the resource from one single-point mooring to another single-point mooring or multiple other single-point moorings. The manifold 12 may be located on or near the sea floor (including buried below the sea floor), below the water surface 15, or on a utility ship at the water surface 15. The manifold 12 may direct the flow of the resource from the offloading ship 40 to the single-point moorings 30c, 30d coupled to the receiving ships 50a, 50b, while stopping the flow of the resource to the empty buoys 30b and 30e. The manifold 12 may have an associated single-point mooring to facilitate loading or discharging the resource.

Unless otherwise specified, the expressions “on or near the sea floor” and variations thereof as used herein, are to be generally understood as encompassing any position beneath the draft of a vessel. For example, unless otherwise specified, a hose, pipe, or other structure which is described as being on or near the sea floor (or variations thereof) may be buried in the seabed, laying on the sea floor, or suspended or floating at a height above the sea floor and below the draft of the deepest vessel which will pass over the particular hose or other structure. In certain situations, local regulations may prescribe that particular structures must be located at a particular location, such as three feet (one meter) under the sea floor.

The offloading and/or receiving ships may be tankers having a deadweight tonnage (DWT) of up to 450,000 DWT and a cargo capacity of 3,000 cubic meters to 520,000 cubic meters. Moreover, the offloading ships may be capable of pumping the resource at a rate of 100 cubic meters per hour to 40,000 cubic meters per hour at a head of up to 200 meters and may include any suitable number (e.g., one, two, three, four, or five) of pumps, such as centrifugal pumps. It is noted that the above-listed capacities and pumping rates may vary based on individual ship design and hardware, and a ship as known in the art may have other suitable capacities and/or pumping rate. While FIG. 1A does not include any pumping station, utility ship, or booster pumps to facilitate transfer (i.e., the offloading ship 40 in FIG. 1A relies solely on onboard pumping capabilities to transfer the resource), other embodiments of the present invention may utilize a pumping station, utility ship, and/or one or more booster pumps as will be explained in further detail below.

The ship-to-ship transfer system 150 of FIG. 1B is substantially similar to the ship-to-ship transfer system 100 of FIG. 1A. In addition, the ship-to-ship transfer system 150 of FIG. 1B includes optional booster pumps 14a-14e positioned at any suitable location along the pipes 20a-20e. The booster pumps 14a-14e may assist the pumping of the resource from the offloading ship 40 to the receiving ships 50a, 50b. The ship-to-ship transfer system 150 includes a manifold 12 connected to each of the single-point moorings 30a-30e as a hub. The manifold 12 may be at a pumping station or on a utility ship, for example, or it may be a stand-alone manifold. The pumping station may be located at a stationary location, such as a specially equipped ship (e.g., utility ship) or a specially-equipped platform (e.g., oil rig) which may be any structure anchored or affixed to the sea floor and below the surface of the water. The pumping station or utility ship may optionally include a booster pump 14f. The manifold may be located at any appropriate location, such as at the surface of the water (for example, on a ship), below the surface of the water, or on or below the sea floor. The pipes 20a-20f are located on or near the sea floor and are coupled to the single-point moorings 30a-30e via pipes or hoses descending to the sea floor.

FIG. 1C illustrates an embodiment of the invention in which two single-point moorings 30a, 30c are directly connected via a pipeline 20 located on or near the sea floor. PLEMs 11a, 11b are deployed below the single-point moorings 30a, 30c, and the PLEMs may be below the surface of the water, for example, on or near the sea floor. Subsea hoses 13a, 13c connect the single-point moorings 30a, 30b to the PLEMs 11a, 11c. One or more booster pumps (not illustrated) may be employed to facilitate the transfer of the resource from the offloading ship 40 to the receiving ship 50a. Valves (not illustrated) may also be incorporated in the system at one or more locations as may be desirable. In this embodiment, a manifold is not necessary as the transfer of the resource occurs directly from one ship-to another ship via the pipeline 20 located on or near the sea floor. In the presence of additional offloading or receiving ships, a manifold will generally be used to direct fluid flows, as discussed elsewhere herein.

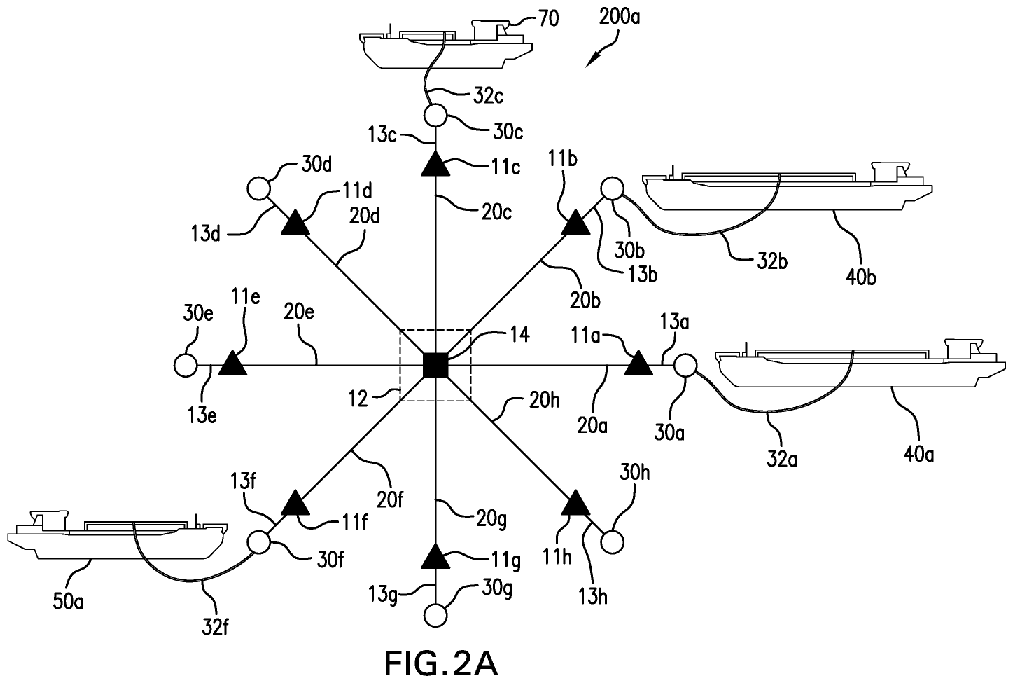

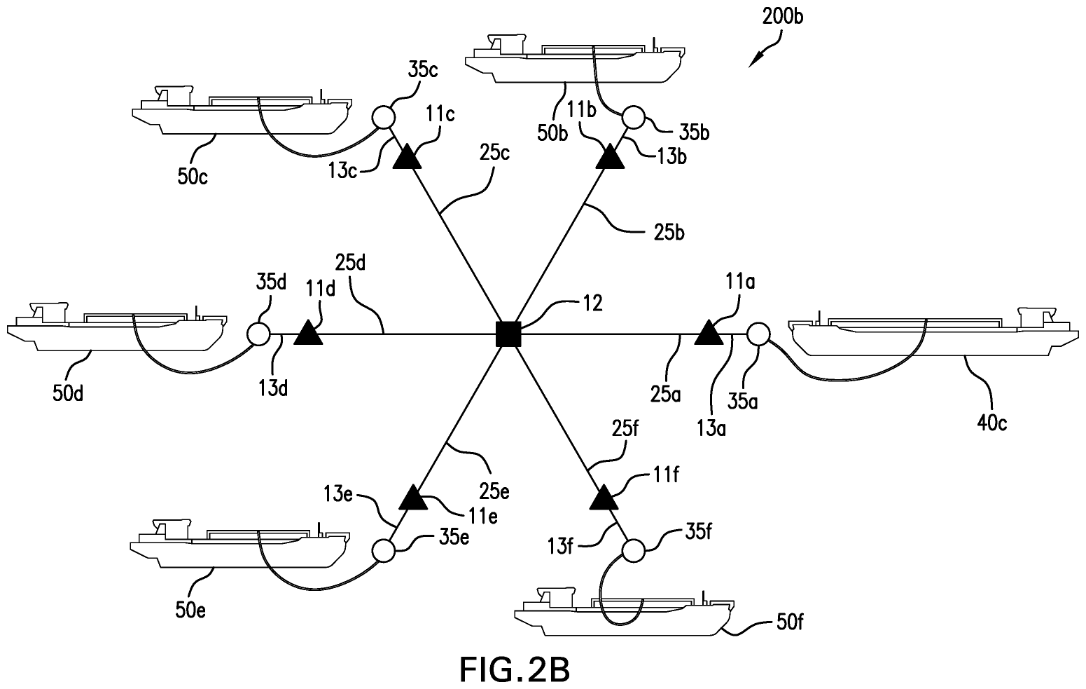

FIG. 2A illustrates a first ship-to-ship transfer system 200a having a pumping station 14 adjacent to a manifold 12 and eight single-point moorings and FIG. 2B illustrates a second ship-to-ship transfer system 200b with a manifold 12 and six single-point moorings 30a-30h connected via respective PLEMs 11a-11h but without a pumping station. Each mooring or other transfer point may also have a respective pumping station below it on or near the sea floor. The pumping station is a booster to the vessel's own pumps to provide additional impetus during transfer of the resource. A manifold is used in the system to direct flow, although in alternative embodiments of the invention, the piping system itself becomes the manifold with the use of valves (not illustrated).

Each ship-to-ship transfer system 200a, 200b may be the same or similar ship-to-ship transfer system 100 described above and illustrated in FIGS. 1A or 1B. As described above, the first transfer system 200a shown in FIG. 2A includes eight single-point moorings (e.g., CALM, SALM, or ELSBM buoys) 30a-30h and the second transfer system of FIG. 2B includes six single-point moorings 35a-35f (although each system may be scalable and include any suitable number of moorings). The transfer systems 200a, 200b may be independently operated, i.e., there is no interconnection of pipes between the two transfer systems 200a, 200b or the two transfer systems 200a, 200b may be fluidly connected to one another. The first transfer system 200a may include the same or different number of single-point moorings as the second transfer system 200b. The second transfer system 200b includes six single-point moorings 35a-35f. Any number of transfer systems may be interconnected for efficient lightering operations in accordance with the invention.

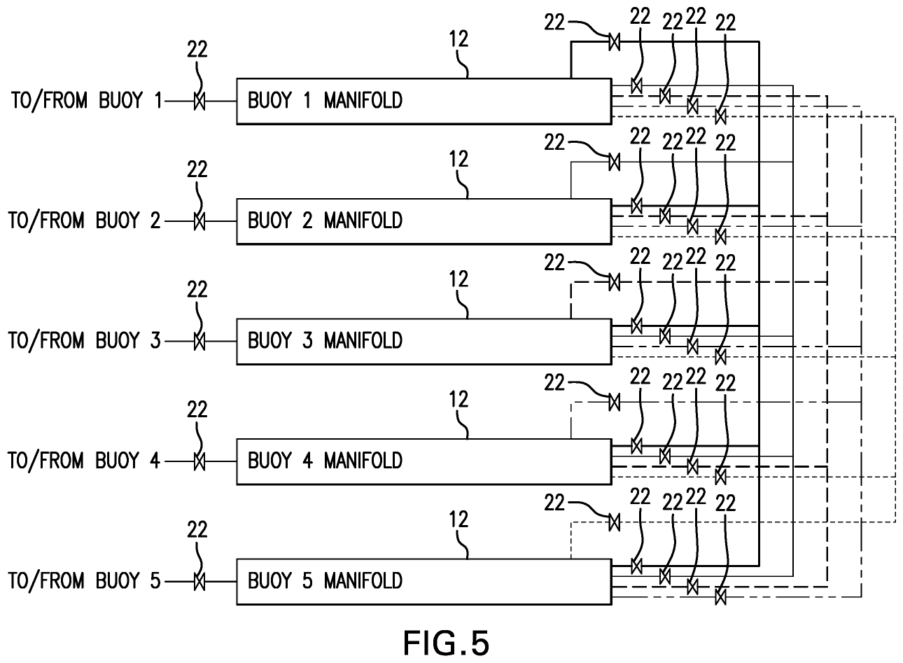

As shown in FIG. 2A, a first offloading ship 40a may connect to a first single-point mooring 30a and a second offloading ship 40b may connect to a second single-point mooring 30b. A receiving ship 50a may connect to a different single-point mooring, such as mooring 30f, which is fluidly coupled to the offloading ships 40a, 40b via floating hose 32f to single-point mooring 30f down through the subsea hose 13f, PLEM 11f, and pipeline 20f to the manifold 12 and single-point moorings 30a, 30b, and then via pipelines 20a, 20b, PLEMs 11a, 11b, and subsea hoses 13a, 14b to buoys 30a, 30b and floating hoses 32a, 32b. Offloading ships 40a, 40b may pump one or more resources (e.g., one, two, three, four, or five resources) to the manifold 12 (shown in FIG. 5). The manifold 12 selectively directs the flow of the resource between the single-point moorings 30a-30h. For example, the manifold may direct the flow of the resource from single-point moorings 30a, 30b through pipe 20f to the single-point mooring 30f. In an embodiment, the one or more resources may be blended and/or temporarily stored while the receiving ship 50 prepares to receive the resource(s) at a utility ship 70 fluidly connected and moored at a single-point mooring 30c.

After the one or more resource is pumped to the manifold 12 (and any other processing, e.g., blending, is performed), the one or more resource may be pumped to the receiving ship 50. Pumping at any point may be supplemented by one or more booster pumps located at any suitable location along the pipe network. The pumping of the one or more resource from each offloading ship 40a, 40b to the utility ship 70 may be directed via the manifold 12 and may be performed simultaneously or at different times and may be performed by the respective offloading ship's onboard cargo pumps. The manifold 12 may be located at any appropriate location, such as on or near the sea floor, below the sea floor, or at or near the surface of the water.

In another embodiment, the pumping station may be replaced by a utility ship. The utility ship may act in the same manner as the pumping station or manifold 12 and receive the resource(s) from the offloading ships 40a, 40b and, using an onboard cargo pump, pump the resource(s) to the receiving ship 50a. Pumping the resource from the offloading ships 40a, 40b to the utility ship and/or the utility ship to the receiving ship 50a may be supplemented with one or more booster pumps along the pipe network.

In another embodiment, as shown in FIG. 2B, a single offloading ship 40c (e.g., a VLCC) may pump a resource to two (or more) receiving ships. In FIG. 2B, five receiving ships 50b, 50c, 50d, 50e, 50f (e.g., AFRAMAX or SUEZMAX ships) are illustrated. Any of the receiving ships 50b, 50c, 50d, 50e, 50f may have an individual smaller cargo capacity than the offloading ship 40c. When the cargo capacities of all receiving ships 50b, 50c, 50d, 50e, 50f are combined through the ship-to-ship transfer system, the receiving ships 50b, 50c, 50d, 50e, 50f may have enough combined cargo capacity to accept all cargo from the offloading ship 40c at one time. This particular embodiment of unloading/discharging a resource from a larger ship into two or more (preferably four or five) smaller ships using the ship-to-ship transfer system described herein may provide improved efficiency to the lightering process because a single large ship can unload the resource to multiple ships concurrently in significantly less time (e.g., about or under 24 hours). Current practice only allows one smaller ship to couple to the larger ship at any given time, thus causing ship-to-ship transfers to be time intensive and heavily dependent on weather. In FIG. 2B, the offloading ship 40c and the receiving ships 50b-50f are interconnected to the manifold 12 via respective single-point moorings 35a-35f and PLEMs 11a-11f.

In another embodiment, a single larger ship (e.g., a VLCC) may be simultaneously loaded from two or more smaller ships (e.g., four AFRAMAX ships). One of skill in the art will understand that the maximum cargo capacity of one VLCC is approximately equal to the combined maximum capacities of four AFRAMAX ships or two SUEZMAX ships.

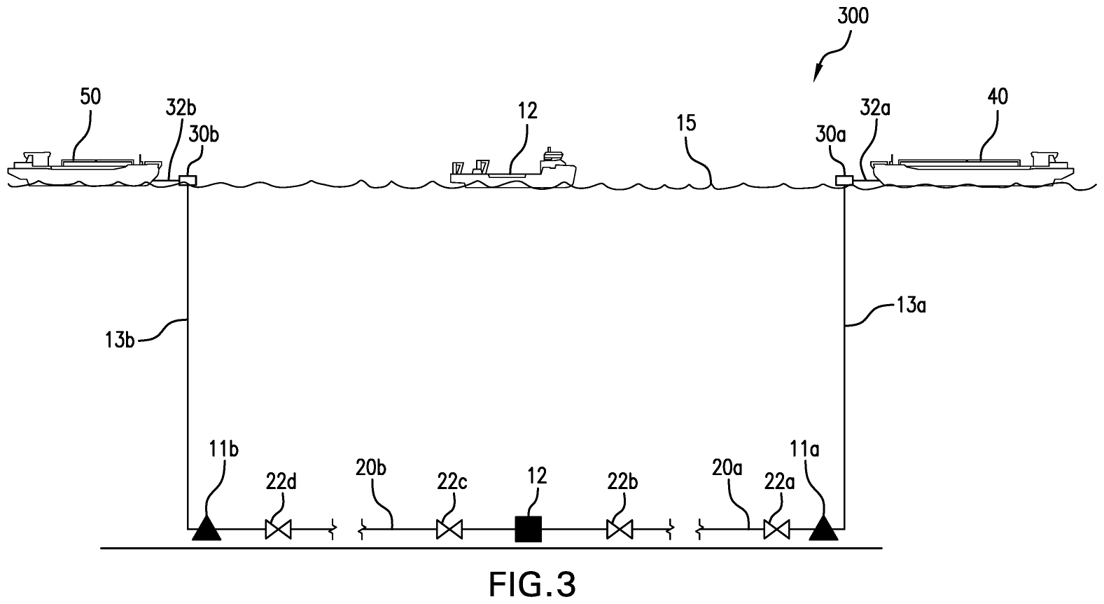

In FIG. 2B, the single-point moorings 35a-35f are connected to the manifold 12 via respective subsea hoses 13a-13f and PLEMs 11a-11f and pipes 25a-25f. The offloading ship 40c and the receiving ships 50b-50f are fluidly coupled to a respective single point mooring 35a-35f via floating hoses 32a-32f, respectively. The manifold 12 may allocate the flow of the resource to each receiving ship 50b-50f such that the receiving ships 50b-50f fill at the same time or at the same rate or at different rates. This differential filling may be achieved through the use of valves (not illustrated) along the pipes as described in more detail in FIG. 3. In an example, if a first receiving ship 50b is to receive more resource than a second receiving ship 50c, the manifold 12 may fill the first receiving ship 50b at a faster rate than the second receiving ship 50c. Alternatively, the manifold 12 can direct flow of the resource to each receiving ship 50b-50f at the same rate via the manifold. The flow of the resource to each receiving ship may be controlled by a control manifold using a series of valves. The manifold 12 may stop the flow of the resource to any receiving ship 50b-50f when the ship reaches its intended cargo quantity, which may be the maximum cargo capacity.

The utility ship or pumping station 70 may be configured to store the resource from the offloading ship 40c prior to pumping the resource into the receiving ships 50b, 50c. For example, when an empty receiving ship couples to a single-point mooring 35a-35f, the utility ship or pumping station 70 may pump the stored resource into the empty receiving ship upon receipt of a command to the utility ship 70 to begin pumping. In general, it is preferred not to use any more pumps than are on board a vessel. In this embodiment, the flow of the resource is directed by a manifold 12, and temporary storage of the resource occur on the utility ship 70 which, in this embodiment, is a ship connected to the system at the center by a single-point mooring. The temporary storage on a utility vessel is typically used only on an as-needed basis in order to minimize costs. In a preferred embodiment, the system operates from ships interconnected using the present invention without the use of a utility ship for temporary storage of the resource. The overall unloading and loading processes discussed with respect to FIGS. 2A and 2B are generally applicable to the other figures and embodiments discussed herein.

In another embodiment, the utility ship may receive the resource(s) from the offloading ship 40c and, using an onboard cargo pump, pump the resource(s) to the receiving ships 50b, 50c at a later time. Pumping the resource from the offloading ship 50c to the utility ship and/or the utility ship to the receiving ships 50b, 50c may be supplemented with one or more booster pumps along the pipe network. With the use of the manifold 12, the flow of the resource would not have to go up to or through the utility ship but, rather, can be directed directly among the other ships attached to the system.

FIG. 3 illustrates a ship-to-ship transfer system 300 wherein an offloading ship 40 and a receiving ship 50 are fluidly coupled to a manifold 12. For ease of understanding, only two ships are illustrated in the figure but it is to be understood that there may be a plurality of offloading and/or receiving ships undergoing ship-to-ship cargo transfer and that the same principles of the invention will apply to any additional vessels. The manifold 12 may be located on or near the sea floor or at the water surface 15 (e.g., on a utility ship, not illustrated). In an example, each of the ships 40, 50 involved in the resource transfer moor to different single-point moorings 30a, 30b. As shown in FIG. 3, the offloading ship 40 connects to single-point mooring 30a and the receiving ship connects to single-point mooring 30b after receiving the tag line connected to respective cargo hoses 32a, 32b and the tag line connected to the respective mooring line on the single-point moorings 30a, 30b. A crane on each ship 40, 50 may be used to lift the cargo hose 32a, 32b from the respective single-point mooring 30a, 30b to connect to the respective ship manifold and thereby fluidly couple the ships 40, 50 to the respective single-point mooring 30a, 30b.

Once a receiving ship 50 is connected to the single-point mooring 30b in the transfer system 300, the offloading ship 40 will start pumping the resource (e.g., oil) through the ship manifold into the cargo hose 32a connected to the single-point mooring 30a and subsea hose 13a and PLEM 11a. The resource will be pumped from the offloading ship 40 through the PLEM 11a and pipes 20a along the seabed until the pipes 20a reach the manifold 12. The manifold 12 is connected to the receiving ship 50 via PLEM 11b which then has a riser connecting it to the single-point moorings [buoy] 30a, 30b from the sea floor. The receiving ship 50 would similarly be connected via the ship manifold to the single-point mooring 30b via cargo hose 32b and subsea hose 13b via PLEM 11b connecting the piping 20b to the manifold 12. In FIG. 3, the manifold 12 is located on near the sea floor but consistent with the invention, the manifold may be located at any location such on or near the surface of the water, below the water surface, or near or below the sea floor. Local regulations may require that particular structures be located at a given location, such as below the sea floor, and such embodiments are within the scope of the scope of the present invention.

The transfer system 300 may further include any suitable number of valves between the single-point moorings 30a, 30b and the manifold 12. In an example, the transfer system 300 may include two valves 22a, 22b between the single-point mooring 30a for the offloading ship 40 and the manifold 12. The transfer system 300 may also include two valves 22c, 22d between the single-point mooring 30b for the receiving ship 50 and the manifold 12. The valves 22a-22d may be operable between open and closed configurations to allow the flow of the resource through the pipes 20a, 20b. The valves 22a-22d may alternatively be used for throttling the flow of the resource or as a stop-check valve. In embodiments of the transfer system having more than two single-point moorings (such as the transfer systems of FIGS. 1 and 2), valves may be selectively opened and closed to direct the flow of a resource. One skilled in the art will understand that any suitable number of valves may be used. For example, one or more valves may be placed at a particular buoy, along the pipes at any point, at the manifold, or at the pumping station/utility ship.

The transfer system 300 may further include any suitable number of booster pumps (not illustrated) at any suitable location along the pipes 20a, 20b. The booster pump(s) may be located on the utility ship in the embodiment where the utility ship acts as a pumping station.

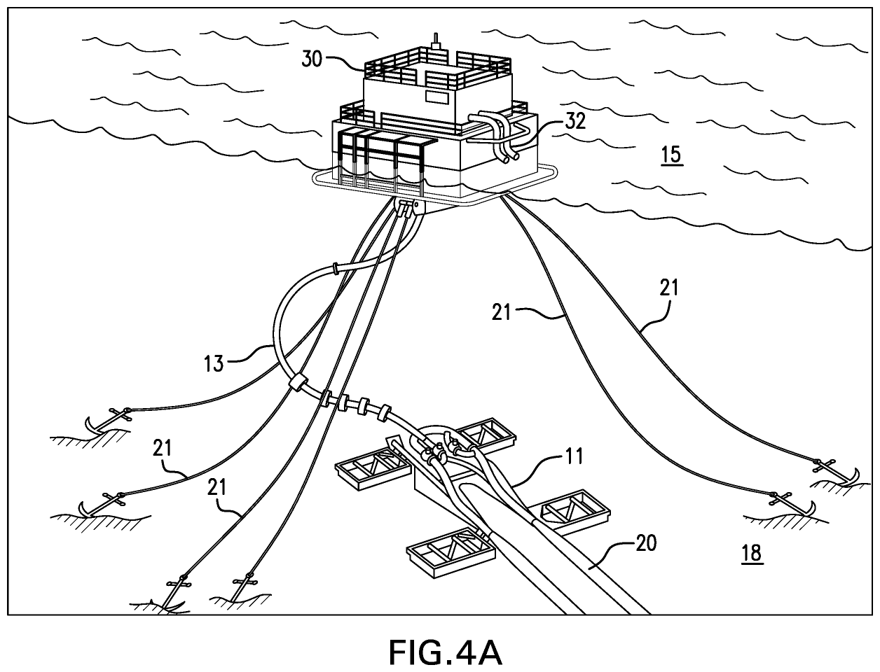

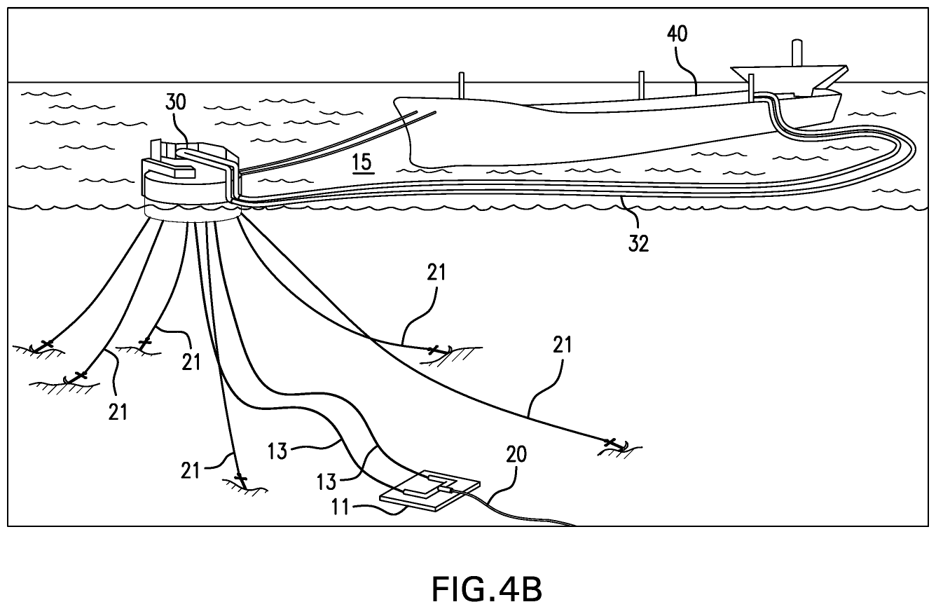

FIGS. 4A and 4B illustrate a CALM buoy that can be used as a single-point mooring 30 for a ship 40 (either an offloading or receiving ship). Other suitable buoys, e.g., SALM or ELSBM, may be used instead of a CALM buoy. The ship 40 may be either an offloading ship or a receiving ship as described above and may fluidly couple to the single-point mooring 30 via a cargo hose (e.g., a floating hose assembly 32). The single-point mooring 30 is positioned at the water surface 15 and is anchored to the sea floor 18 via anchor lines 21. The single-point mooring 30 further includes a subsea hose 13 (e.g., a riser) extending from the single-point mooring 30 to the PLEM 11 on or near the sea floor 18 where the pipe 20 will connect to a manifold 12 (not illustrated). The manifold 12 may connect to one or more additional single-point moorings as described above.

FIG. 5 illustrates five interconnected manifolds 12. In one example, such as a manifold used for the embodiment of the ship-to-ship transfer system 200b shown in FIG. 2B, the manifolds 12 may include pipes corresponding to each single-point moorings 35a-35f. The manifolds 12 may include any suitable number of pipes so that the resource may be pumped between any two of the single-point moorings 35a-35f. The manifolds 12 may include valves 22 or the valves may be a part of the pipes that connect the manifolds 12 together to thereby control flow of the resource between the single-point moorings. The manifolds 12 may include one or more booster pumps to provide additional pumping power to the system. The booster pump may be located at any suitable location along the pipe network in between single-point moorings. Although five manifolds are illustrated in FIG. 5, any number of manifolds can be interconnected to perform lightering operations in accordance with the present invention.

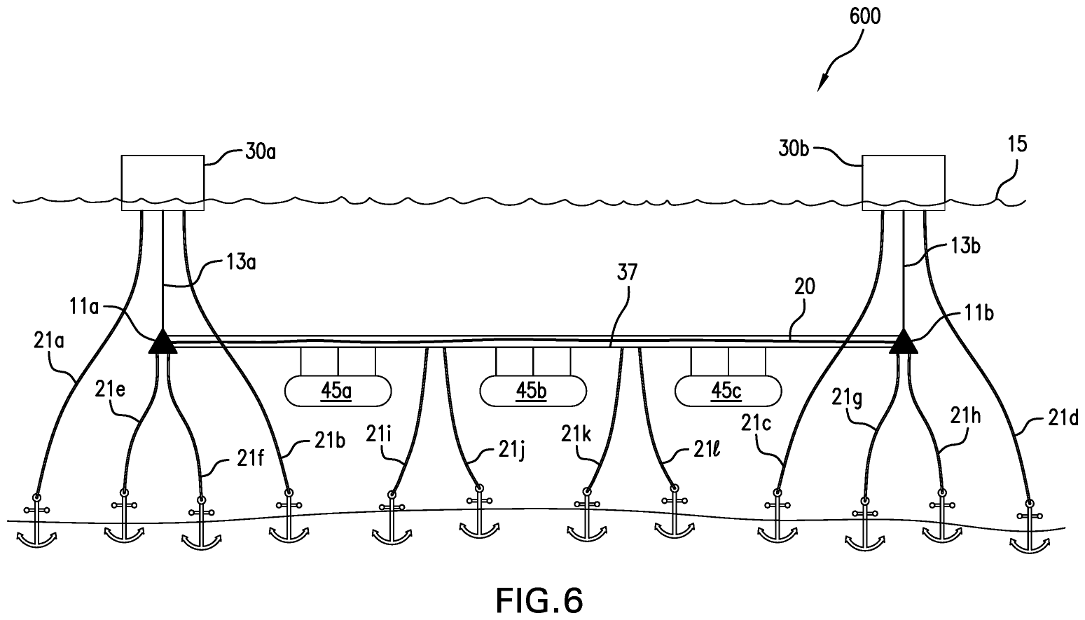

FIG. 6 illustrates an embodiment of a ship-to-ship transfer system 600 in which single-point moorings are fluidly connected via a floating or suspended underwater piping system. In alternative embodiments, the single-point moorings may be connected via a piping system which is on the surface of the sea floor or buried into the sea floor. In FIG. 6, a pair of single point moorings 30a, 30b on the water surface 15 are anchored via a plurality of anchor lines 21a-21d to the sea floor 18. Each single-point mooring 30a, 30b is fluidly connected to a pipeline 20 via subsea hose 13a, 13b and PLEM 11a, 11b. The pipeline 20 and PLEMs 11a, 11b as well as manifold 12 (not illustrated) are partly buoyant in the water and are anchored to the sea floor via anchor lines 21e-21h. The PLEMs 11a, 11b as well as manifold 12 (not illustrated) are fluidly connected via a piping system comprising one or more pipes 20. The pipes 20 can have any particular dimensions or material of construction as previously discussed. For avoidance of doubt, the pipes 20 may be in the form of rigid or flexible tubes, hoses, or other conduits which allow passage of fluids between manifolds. It will be understood that the piping system formed by the pipes 20 and hoses 13 are in fluid connection.

Ballast floats 45a-45c are used to maintain the pipes 20 encased in infrastructure 37 at a distance above the sea floor 18. The ballast floats 45a-45c may have any convenient structure or configuration, and can be hollow, filled, or partly-filled with a substance such as a liquid or gas to provide the desired buoyancy. The buoyancy of the ballast floats 45a-45c may be fixed or variable. In the latter case, the buoyancy can be adjusted to raise or lower the pipes 20 within infrastructure 37 as may be desirable, for example, to raise the pipes 20 to the water surface 15 for maintenance and subsequently to lower the pipes to their prior height above the sea floor 18. Offloading and receiving ships and have not been shown in the figure for ease of illustration. Elements such as booster pumps and/or a pumping station may be included in the embodiment of FIG. 6 as may be desirable.

The various underwater components of the embodiment in FIG. 6 are deployed at a height above the sea floor 18 which is below the draft of the largest vessel which may be expected to pass over the components. This height above the sea floor will depend on the particular undersea topography and the height of the water column at lowest tide, and will be evident to a person of skill. In an alternative embodiment (not illustrated), instead of using underwater ballast floats, support structures such as pillars, posts, or other elements may be erected on the sea floor and the underwater components such as infrastructure 37 affixed to the support structures.

A method of using the ship-to-ship transfer systems described above includes providing a first mooring in fluid communication with a second mooring; and pumping the resource from a first ship (using the cargo pump of the first ship) fluidly coupled to the first mooring into a second ship fluidly coupled to the second mooring. In the embodiment with a pumping station or utility ship, the method may include pumping the resource from the first mooring to the pumping station or utility ship. The pumping station or utility ship may then pump the resource into one or more receiving ships using a control manifold to direct the flow of the resource. In an example, a customer/user who wishes to discharge a cargo of oil to one or more ships would moor their ship (e.g., a VLCC) to one of the single-point moorings (e.g., CALM, SALM, or ELSBM buoys) and the receiving ship (e.g., an AFRAMAX or SUEZMAX ship) would moor to one of the other available single-point moorings (e.g., CALM buoys). The distance between the two ships during cargo operations would be sufficiently spaced apart based on weather conditions and may be 100 m to 5 km apart. The customer/user would also be able to, in the case there were more than two single-point moorings available, be able to simultaneously discharge cargo into two (or more) different receiving ships (e.g., two different AFRAMAX or SUEZMAX ships). Preferably, a single VLCC ship will pump its cargo using the system described herein to four (or more) AFRAMAX ships or to two (or more) SUEZMAX ships to allow the lightering process to be completed in about a day. It should be understood that even though the present specification is directed to oil or oil products, the ship-to-ship transfer system could be used for transferring other types of fluids, such as chemicals, slurries, natural gas, fuel, or other liquids and/or gases.

Variations and modifications will occur to those of skill in the art after reviewing this disclosure. The disclosed features may be implemented, in any combination and subcombination (including multiple dependent combinations and subcombinations), with one or more other features described herein without limitation. The various features described or illustrated above, including any components thereof, may be combined or integrated in other systems. Moreover, certain features may be omitted or not implemented.

Examples of changes, substitutions, and alterations are ascertainable by one skilled in the art and could be made without departing from the scope of the invention disclosed herein. All references cited herein are incorporated by reference in their entirety and made part of this application.

What is claimed is:

1. A ship-to-ship transfer system comprising:
a first mooring positioned at a water surface and anchored to an sea floor; and
a second mooring positioned at the water surface and anchored to the sea floor, said second mooring in fluid communication with the first mooring via a pipe.

2. The ship-to-ship transfer system of claim 1, further comprising a third mooring positioned at the water surface and anchored to the sea floor, said third mooring in fluid communication with the first mooring and the second mooring via the pipe.

3. The ship-to-ship transfer system of claim 1, further comprising a pumping station positioned at a stationary location having a pump, said pumping station fluidly coupled in between the first mooring and the second mooring.

4. The ship-to-ship transfer system of claim 1, further comprising a manifold fluidly coupled to the first and second moorings.

5. The ship-to-ship transfer system of claim 1, further comprising a first hose extending from the first mooring and a second hose extending from the second mooring, wherein the first hose and the second hose are capable of coupling to a cargo manifold of a ship.

6. The ship-to-ship transfer system of claim 1, wherein the first mooring and second mooring are spaced apart at a distance of between about 0.1 km to about 5 km.

7. The ship-to-ship transfer system of claim 6, wherein the first mooring and second mooring are spaced apart at a distance of about 1.5 km.

8. The ship-to-ship transfer system of claim 3, further comprising a first valve between the pumping station and the first mooring.

9. The ship-to-ship transfer system of claim 8, further comprising a second valve between the pumping station and the second mooring.

10. The ship-to-ship transfer system of claim 3, wherein the stationary location is an sea floor or a platform.

11. The ship-to-ship transfer system of claim 3, wherein the stationary location is a floating platform.

12. The ship-to-ship transfer system of claim 3, wherein the pumping station is a utility ship, wherein the utility ship is a specially-equipped tanker or specially-equipped platform.

13. The ship-to-ship transfer system of claim 3, wherein the pumping station comprises a manifold having a plurality of crossover pipes and a plurality of valves.

14. The ship-to-ship transfer system of claim 3, said system further comprising a booster pump.

15. The ship-to-ship transfer system of claim 1, wherein the pipe is on the sea floor, buried in the sea floor, or suspended or floating at a height above the sea floor.

16. A method of transferring a resource from one ship to another, the method comprising:
providing a first mooring in fluid communication with a second mooring; and
pumping the resource from a first ship fluidly coupled to the first mooring into a second ship fluidly coupled to the second mooring.

17. The method of claim 16, further comprising the step of providing a pumping station having a pump, said pumping station in fluid communication between the first mooring and the second mooring.

18. The method of claim 16, further comprising adjusting a valve to alter flow of the resource from the first ship to the second ship.

19. The method of claim 17, further comprising adjusting a first valve to alter flow of the resource between the first ship and the pumping station.

20. The method of claim 19, further comprising adjusting a second valve to alter flow of the resource between the pumping station and the second ship.

21. The method of claim 16, said first mooring is laterally spaced from said second mooring by a distance of about 0.1 km to about 5 km.

22. The method of claim 21, said first mooring is laterally spaced from said second mooring by a distance of about 1.5 km.

23. The method of claim 16, further comprising the step of providing a manifold to direct fluid flow among the moorings.

24. The method of claim 16, further comprising providing three or more moorings and a manifold to direct fluid flow among the moorings.
